(19) United States
(12) Patent Application Publication
(10) Pub. No.: US 2022/0411969 A1
(43) Pub. Date: Dec. 29, 2022

(54) FIBERS, COMPOSITE MATERIALS FORMED WITH SUCH FIBERS, AND METHODS FOR FORMING SUCH COMPOSITE MATERIALS

(71) Applicant: FIBERVISIONS LP, Duluth, GA (US)

(72) Inventors: Søren STAAL, Esbjerg (DK); Søren KLINT, Esbjerg (DK); Prashant DESAI, Athens, GA (US)

(21) Appl. No.: 17/775,670

(22) PCT Filed: Dec. 2, 2020
(86) PCT No.: PCT/US2020/062839

§ 371 Date: May 10, 2022

Related U.S. Application Data
(60) Provisional application No. 62/942,819, filed on Dec. 3, 2019.

(51) Int. Cl. D01F 8/06; D01F 1/02; D01D 1/04

(52) U.S. Cl. CPC D01F 8/06; D01F 1/02; D01D 1/04

(57) ABSTRACT

A representative fiber incorporates: a low melting polyolefin material forming a matrix; and a polymer or copolymer suspended in the matrix as particles of the polymer or copolymer, the particles of the polymer or copolymer exhibiting increased hardness and stiffness compared to the low melting polyolefin material; wherein the polymer or copolymer is immiscible with the low melting polyolefin.

### CROSS REFERENCE TO RELATED APPLICATION

This utility patent application claims the benefit of and priority to U.S. Provisional Patent Application 62/942,819, filed 3 Dec. 2019, which is incorporated herein by reference in its entirety.

### BACKGROUND

### Technical Field

The present invention relates to synthetic fibers and composite materials formed with synthetic fibers.

### Description of the Related Art

Thermoplastic matrix composites with natural materials are desirable from a sustainability perspective. Composites can be made with thermoplastic fibers using a number of techniques such as carding, weaving, knitting, intermingling, wet laid, air laid, air lay, etc. The thermoplastic can be consolidated by heating the thermoplastic fibers. To form a uniform and intimate blend of the thermoplastic and natural materials, the thermoplastic should be processed depending on the needs of the composite process, such as described in various references (for example, Thermoplastics and Thermoplastic Composites (ISBN13: 9780080489803), Wood-Plastic Composites (ISBN13: 9780470165928), and Composite Nonwoven Materials: Structure, Properties and Applications (ISBN13: 9780857097750). Generally, it is desirable to distribute the thermoplastic in the mixture and reduce friction between the thermoplastic materials.

Openability is crucial for optimal bonding and minimizing the amount of synthetic filaments and fibers needed. Therefore, it is often desirable for the surface of the synthetic fiber to be as frictionless as possible in filament-to-filament interaction and as stiff as possible in order to avoid the synthetic filaments wrapping around each other or interacting, which otherwise would hamper separation. This can be achieved by using conventional thermoplastic binders with relatively high melting points and crystallinity. For instance, high density polyethylene (HDPE), with a melting temperature around 130° C. used as sheath material in a bi-component fiber or as the sole component in a mono-component fiber, gives the fiber stiffness and hardness enough to provide sufficient openability. However, natural substrates tend to degrade and generate volatile organic compounds (VOCs) at elevated temperatures used with conventional thermoplastic composites.

One solution for reducing VOCs is to use lower melt point thermoplastic binders. For instance, polyethylene grades with a lower melting temperature such as medium density polyethylene (MDPE), linear low-density polyethylene (LLDPE), low density polyethylene (LDPE) or ultra-low density polyethylene (ULDPE) can be used. However, these thermoplastic binders are softer and tend to exhibit more material friction, which hinders openability when present at the surface of a fiber.

To reduce contact and friction between individual filaments and fibers, inorganic particles can be incorporated into the low melting polyolefin, as described in U.S. Pat. No. A-5,994,244 and EP-1,350,869-A1. According to U.S. Pat. No. A-5,994,244 inorganic particles such as titanium dioxide, silicon dioxide, calcium carbonate, talc or similar, exposes the surface of filament and creates unevenness that reduces contact between filaments. However, the presence of inorganic particles reduces the adhesion potential of the low melting polyolefin and of the fiber. Furthermore, the presence of hard inorganic particles with irregular and sharp surfaces in a polymer surface may result in abrasion of surfaces in manufacturing and increased wear, leading to an increase in maintenance and more frequently replacement of parts. Moreover, inorganic particles may not be desirable due to imparted color and/or increased density of the fibers.

### SUMMARY

Fibers, composite materials formed with such fibers, and methods for forming such composite materials are provided. In this regard, an example embodiment of a fiber comprises: a low melting polyolefin material forming a matrix; and a polymer or copolymer suspended in the matrix as particles of the polymer or copolymer, the particles of the polymer or copolymer exhibiting increased hardness and stiffness compared to the low melting polyolefin material; wherein the polymer or copolymer is immiscible with the low melting polyolefin.

In some embodiments, the low melting polyolefin material is exposed along at least a portion of the exterior surface of the fiber.

In some embodiments, the polymer or copolymer is exposed along at least a portion of the exterior surface of the fiber.

In some embodiments, the fiber is an extruded fiber.

In some embodiments, the polymer or copolymer is selected from one or more of the group consisting of: polyethylene terephthalate, polybutylene terephthalate, polylactide, polyamide, polystyrene, polyvinyl alcohol, and acrylonitrile-butadiene-styrene.

In some embodiments, the polymer or copolymer is selected from one or more of the group consisting of: polyethylene terephthalate, polybutylene terephthalate, polylactide, and polyamide.

In some embodiments, the polymer or copolymer is polylactide.

In some embodiments, the polymer or copolymer suspended in the matrix is between 1% and 25% by weight of the low melting polyolefin.

In some embodiments, the fiber is a bi-component fiber.

In some embodiments, the bi-component fiber has a core and a sheath.

In some embodiments, the sheath is formed of the low melting polyolefin material and the polymer or copolymer is suspended in the matrix.

In some embodiments, the core is formed of one or more of the group consisting of: polypropylene, high density polyethylene, copolypropylene, and polyester terephthalate.

In some embodiments, the core is formed of polypropylene.

In some embodiments, the polymer or copolymer suspended in the matrix is between 1% and 25% by weight of the low melting polyolefin material.

An example embodiment of a composite material comprises: a substrate; and a plurality of fibers bonded to the substrate, wherein each of the plurality of fibers comprises: a low melting polyolefin material forming a matrix; and a polymer or copolymer suspended in the matrix as particles of the polymer or copolymer, the particles of the polymer or copolymer exhibiting increased hardness and stiffness compared to the low melting polyolefin material, the polymer or copolymer being immiscible with the low melting polyolefin.

In some embodiments, each of the plurality of fibers is an extruded fiber.

In some embodiments, the low melting polyolefin material is exposed along at least a portion of the exterior surface of the fiber.

In some embodiments, the polymer or copolymer is exposed along at least a portion of an exterior surface of each of the plurality of fibers.

In some embodiments, the plurality of fibers are bonded to the substrate by a melt bond.

In some embodiments, both the low melting polyolefin material and the polymer or copolymer suspended in the matrix are melted to form the melt bond.

An example embodiment of a method for forming a composite material comprises: providing a plurality of fibers, wherein each of the plurality of fibers comprises: a low melting polyolefin material forming a matrix; and a polymer or copolymer suspended in the matrix as particles of the polymer or copolymer, the particles of the polymer or copolymer exhibiting increased hardness and stiffness compared to the low melting polyolefin material, the polymer or copolymer being immiscible with the low melting polyolefin; providing a substrate; melting the low melting polyolefin material of the plurality of fibers to bond the plurality of fibers to the substrate; and cooling the low melting polyolefin material and the substrate to solidify the composite material.

In some embodiments, providing the plurality of fibers comprises: mixing the low melting polyolefin material and the polymer or copolymer to form a mixture; melting the low melting polyolefin material and the polymer or copolymer of the mixture; and extruding the mixture to form the fibers.

In some embodiments, extruding the mixture comprises extruding the mixture about a core.

In some embodiments, the melting further comprises melting the polymer or copolymer of the plurality of fibers to bond the plurality of fibers to the substrate.

In some embodiments, prior to the melting and while at a temperature below a glass transition temperature of the polymer or copolymer, the method further comprises: opening the plurality of fibers; and disposing the plurality of fibers on the substrate.

In some embodiments, the method further comprises: opening the plurality of fibers; and layering the plurality of fibers on the substrate to form a laminate.

In some embodiments, providing the substrate comprises providing substrate components.

In some embodiments, the method further comprises: opening the substrate components and the plurality of fibers; and mixing the substrate components and the plurality of fibers to form a web.

In some embodiments, the substrate components are substrate fibers.

In some embodiments, the method further comprises compressing the substrate components and the plurality of fibers.

### BRIEF DESCRIPTION OF THE SEVERAL VIEWS OF THE DRAWINGS

A more complete understanding of the disclosure may be had by reference to the following Detailed Description when taken in conjunction with the accompanying drawings, in which like reference numerals indicate corresponding parts throughout the several views.

FIG. 1 is a schematic view of an example of a fiber.

FIG. 2 is a schematic cross-sectional view of the fiber of FIG. 1.

FIG. 3 is a flowchart of an example method for forming a fiber.

FIG. 4 is a flowchart of an example method for forming a composite material.

FIG. 5 is a schematic diagram showing an example method for forming a composite material in relation to a representative temperature profile.

FIG. 6 is a table depicting fiber samples prepared with different additives.

FIG. 7 is a graph depicting results of an openability test as measured in mass of fibers.

FIG. 8 is a graph depicting results of another openability test measured in content percentage versus mass of fibers.

### DETAILED DESCRIPTION

Various fibers, composite materials formed with such fibers, and methods for forming such composite materials involve the use a low melting polyolefin material forming a matrix and a polymer or copolymer suspended in the matrix. As used in this disclosure, a low melting polyolefin is a polyolefin with a melting temperature below 150° C. It should be noted that the “or” in “polymer or copolymer” as used in this disclosure is meant in an inclusive sense, in that polymer, copolymer, or both polymer and copolymer may be used depending on the application. Owing to the polymer or copolymer being immiscible with the low melting polyolefin, the polymer or copolymer is suspended in the matrix as particles of the polymer or copolymer. These particles exhibit increased hardness and stiffness compared to the low melting polyolefin material. Thus, the fibers may exhibit decreased surface flexibility compared to the surface flexibility of a fiber of similar dimensions formed of the low melting polyolefin (that is, without the polymer or copolymer). Additionally, the polymer or copolymer may be exposed along at least a portion of the exterior surface of the fiber, thus potentially further enhancing the openability of the fibers. Notably, openability is a measure of how easily fibers can be separated from one another. For the avoidance of doubt, fibers could be staple, filament or formed by spunmelt process.

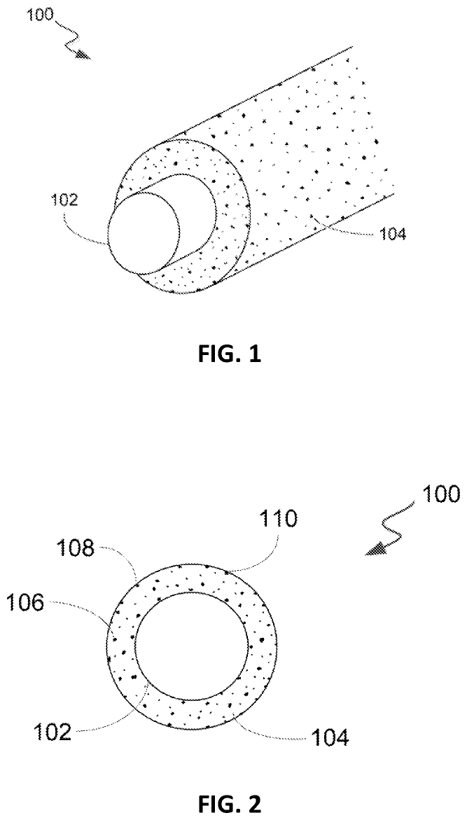

An example of a fiber 100 is depicted in FIGS. 1 and 2. As shown, fiber 100 is a bi-component fiber that incorporates a core 102 and a sheath 104. Sheath 104 is formed of a low melting polyolefin material forming a matrix and a polymer or copolymer suspended in the matrix. Specifically, sheath 104 includes particles of the polymer or copolymer (e.g., particles 106, 108). For instance, particle 106 is embedded within and surrounded by the low melting polyolefin material and, in this example, particle 108 is exposed at the exterior surface 110 of sheath 104. So configured, the low melting polyolefin material is exposed along at least a portion of the exterior surface of fiber 100. It should be noted that, in some embodiments, none of the particles of polymer or copolymer may be exposed at the exterior surface. Note also that, in fiber 100, the low melting polyolefin makes up at least 20% of the total mass of the fiber.

Although FIGS. 1 and 2 depict a bi-component fiber, various other configurations (such as mono-component fibers) may be used. Additionally, although fiber 100 is generally shown as a 50/50 core and sheath bi-component fiber, various other configurations of bi-component fiber may be used. By way of example, other core and sheath configurations, such as 20/80, eccentric, and trilobal may be used. Alternatively, various side-by-side, tipped, and micro-denier configurations, among others, may be used.

In some fibers, the core may be formed of one or more of polypropylene, high density polyethylene, copolypropylene, or polyester terephthalate, with polypropylene being preferred in some applications (see, for example, Handbook of Fiber Chemistry (ISBN13: 9781420015270)). Further, in some fibers, the polymer or copolymer may be of polyester, polylactide or polyamide origin. By way of example, in some fibers, the polymer or copolymer may be formed of one or more of polyethylene terephthalate, polybutylene terephthalate, polylactide, polyamide, polystyrene, polyvinyl alcohol, or acrylonitrile-butadiene-styrene. In some applications, the polymer or copolymer preferably may be formed of one or more of polyethylene terephthalate, polybutylene terephthalate, polylactide, and polyamide, while, in other applications, the polymer or copolymer is most preferably formed of polylactide.

In some fibers, the polymer or copolymer suspended in the matrix is from 1-25% by weight of the low melting polyolefin material. In some fibers, the polymer or copolymer suspended in the matrix preferably is at least 2% by weight of the low melting polyolefin material. Additionally, or alternatively, the polymer or copolymer suspended in the matrix preferably is at most 15% by weight of the low melting polyolefin material. In some fibers, the polymer or copolymer suspended in the matrix most preferably is between 7% and 13% by weight of the low melting polyolefin material.

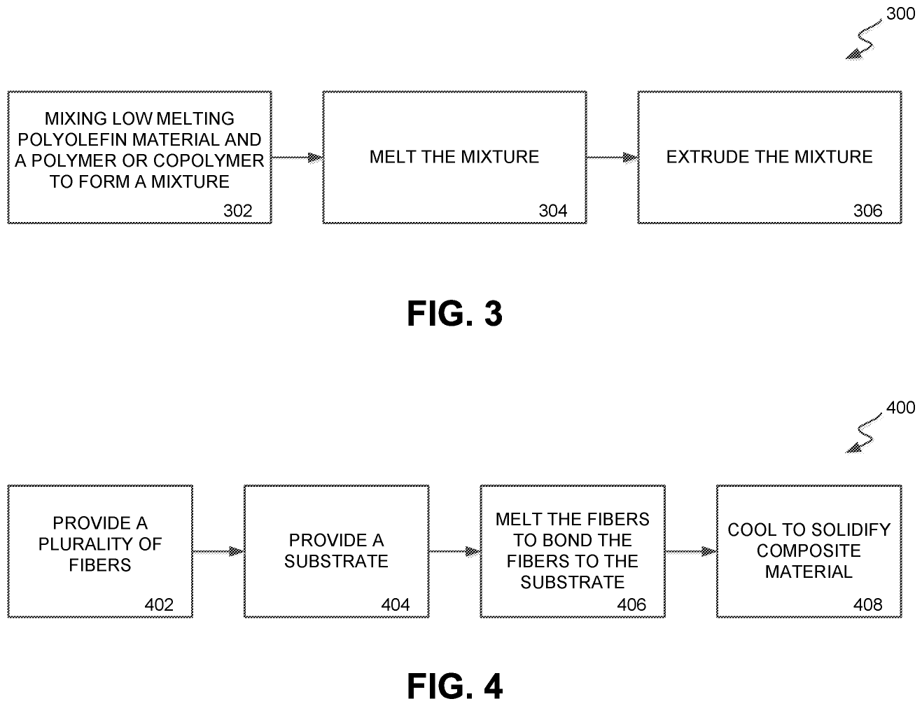

In order to provide fibers with the desired characteristics (such as fiber 100 of FIGS. 1 and 2), a method such as depicted in FIG. 3 may be performed. As shown in FIG. 3, method 300 involves mixing a low melting polyolefin material and a polymer or copolymer to form a mixture (block 302). The mixture is then melted (block 304) and subsequently extruded to form a fiber (block 306). In some applications, the extrusion process may include extruding the mixture about a core to form a bi-component fiber. Notably, a method of forming a fiber may involve a cutting step to form fibers from a continuous filament. In some applications, continuous thermoplastic filaments with titer ranging from 0.5 to 50 dTex/filament, monofilament with diameter ranging from 0.05 to 1.0 mm or staple cut fibers with titer ranging from 0.5 to 50 dTex/filament and with fiber length of 0.5 mm to 150 mm are provided.

During the extrusion process, the polymer or copolymer divides into colloid-like particles suspended in a matrix of the low melting polyolefin material, as phase separation occurs due to incompatibility of the materials (see, for example, Specific Interactions and the Miscibility of Polymer Blends (ISBN13: 9780877628231) and The Physics of Polymers: Concepts for Understanding Their Structures and Behaviour (ISBN13: 9783540632030)). When extruded into filaments and the molten phases are cooled, the suspended particles are locked in the matrix. The particles create areas of increased hardness and greater density throughout the softer and less dense matrix. The particles decrease the surface flexibility of the fiber and increase the apparent hardness of the exterior surface, thus decreasing the risk of fibers entangling and interacting in an opening process, wet or dry. In some applications, the thermoplastic melt phase of the low melting polyolefin material intended for bonding can also contain an adhesion promoter or coupling agent intended to improve affinity and bonding to substrates (see, for example, Wood-Plastic Composites (ISBN13: 9780470165928). In some applications, various adhesion promoters, such as maleic anhydride, maleic acid, acrylic acid, methyl acrylate, butyl acrylate, ethyl acrylate, epoxides, and/or vinyl acetate may be used.

As mentioned before, fibers may be used for forming composite materials. In this regard, an example method for forming composite materials is depicted in FIG. 4. As shown in FIG. 4, method 400 involves providing a plurality of fibers (block 402). Specifically, each of the plurality of fibers incorporates a low melting polyolefin material forming a matrix and particles of a polymer or copolymer suspended in the matrix. In block 404, a substrate is provided. Depending upon the application, the fibers and substrate may be arranged variously, such as in layers to form a laminated structure or as in an intermingled configuration to form a web, among numerous others. As depicted in block 406, the low melting polyolefin material of the plurality of fibers is melted to bond the plurality of fibers to the substrate. It should be noted that, in some applications, both the low melting polyolefin material and the polymer or copolymer suspended in the matrix are melted to form a melt bond with the substrate. Thereafter, such as depicted in 408, the materials of the fibers and substrate are cooled to solidify the composite material.

The aforementioned fibers can be in the form of continuous filaments. Notably, there are composite manufacturing processes where the reinforcing fiber and the thermoplastic binders are initially continuous filaments. The filament yarns are combined to form a tape or commingled yarn that can be converted via weaving, braiding, etc. into three-dimensional composite forms. A requirement in such processes is that the filament yarns exhibit low surface friction. In processes such as described in U.S. Pat. No. 10,265,885B2, WO2018229136A1 and WO2019162324A1, the filament yarns are spread to form intimate contact between the reinforcing and the binder yarns. This requires the binder filaments to be easily separable. The reinforcement fibers can be any fiber with a melting point higher than that of the binder yarns. For example, glass and carbon fibers are commonly used. Filaments from viscose or lyocell filament yarns can be used as a renewable source reinforcement fiber.

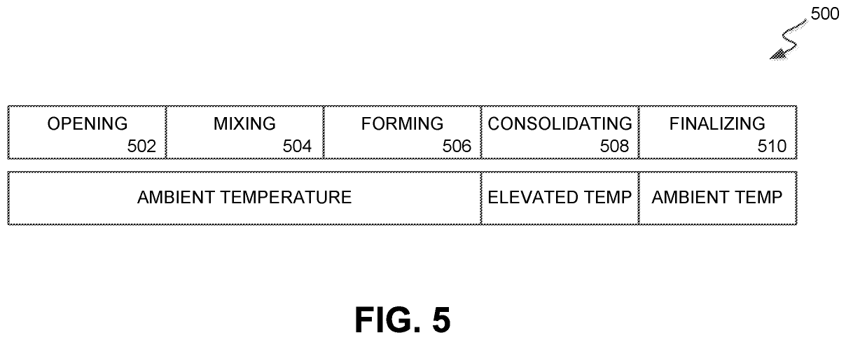

Fundamental process steps in the making of a composite material also are depicted in FIG. 5, which may be representative of numerous processing techniques, such as airlaid, air lay and wetlaid, for example. As shown in FIG. 5, method 500 begins with opening 502, which involves opening of the fibers, such as with air or water, to reduce fiber entanglement and provide a desired distribution of the fibers. In 504, the now-opened fibers are mixed with substrate components, after which the mixture of fibers and substrate components is formed in 506. It should be noted that 502-506 are performed at a temperature (e.g., ambient temperature) that is below the glass transition temperature for the polymer or copolymer of the fibers to avoid the negative effect to adhesion. Processing of the fibers at such temperatures maintains the hardness and stiffness of the fibers and reduces fiber interaction. For example, polymer or copolymer with a glass transition temperature above 50° C., preferably above 60° C., may be used.

In 508, the formed mixture of fibers and substrate components is consolidated (or bonded) such as by heating the mixture to an elevated temperature to melt the fibers and optionally compressing the mixture (see, for example, Nonwovens: Process, Structure, Properties and Applications (ISBN13: 9781315341347), Handbook of Nonwovens (ISBN13: 9781845691998), and Composite Nonwoven Materials: Structure, Properties and Applications (ISBN13: 9780857097750)). Above the glass transition temperature where the copolymer is soft and partially or fully melted, the polymer or copolymer particles interfere in a lesser degree in the bonding process compared to inorganic particles. Additionally, abrasion caused by hard inorganic particles, can be avoided, decreasing the need for maintenance of manufacturing equipment. In 510, finalizing is performed, which involves cooling the consolidated/bonded web to form the composite.

In the context of an airlaid process, the general process described above may involve the following. In particular, natural and synthetic fibers may be opened and mixed with air, then transferred to a forming step, where the mix passes through a static or dynamic screen to form a web on a moving belt or wire. The web can then be consolidated through various approaches such as thermal bonding and hydroentangling. Typical substrate materials (or substrate components) utilized in an airlaid process include fine, purified or refined cellulosic fibers with cotton or wood origin. Inorganic substrate materials, like glass fibers, also may be used in an airlaid web-forming process. The web formed through an airlaid process tend to be relatively flat sheet, 2-dimensional products such as, for example, cores for feminine care or diapers, towels, napkin paper and meat pads for food packaging.

In an air lay process, which is similar to an airlaid process, fibers are opened and mixed in an airstream. However, after an initial opening by air, the fibers are additionally subjected to shear work from spike formers, spike rollers or similar, which further mixes and blends the materials. Afterwards, the web is transferred to a conveyer belt or wire and consolidated most typically by thermal bonding. A key advantage of the airlay process is its ability to handle longer fibers, and more coarse and rigid substrate materials, which would not be able to be fed through the screens in a typical airlaid process. The design of a typical airlay process makes it robust in handling less refined substrates with a cellulosic make-up like coarse wood fiber, wood shavings, hemp, flax and the like; or recycled or reused materials like waste textiles, reclaimed carbon fiber, etc.

The web formed in an airlay process is usually thicker and exhibits a more 3-dimensional form compared to airlaid. These include products like insulation board made from wood fibers or recycled paper bonded together with synthetic thermoplastic fibers. Boards of synthetic and natural fibers and be compressed and exposed to a heating and cooling cycle, so that the synthetic phase melts and fills the pores and void between the substrate. When cooled, the synthetic phase returns to solid state and fixates the compressed shape of the board when pressure is removed. This can be used to produce high density composite materials, with either a 2- or 3-dimensional shapes. An example of non-natural substrate may be reclaimed carbon fiber waste that is blended with a fiber configured for thermal bonding. The materials are formed into a lofty web and then compressed under elevated temperatures to form a dense panel with a 3-dimensional form. Needle punching may provide an alternative measure of consolidation to thermal bonding in an airlay process.

In a wetlaid process, water is used as the media of dispersion rather than air. Like for the airlaid process, the substrates are typically fine and refined cellulose fibers that can be blended with synthetic fibers. However, glass fiber is also known to be used as a substrate in wetlaid processes. The water slurry of substrate material and synthetic fibers can then be sprayed onto a moving forming belt or wire, which is permeable to let water pass. The web is then dried and thermally bonded to form a flat and sheet-like material. The products that use a wetlaid process for forming typically include tea paper, coffee filters, battery separators, air filters, papers of various kinds, etc.

A carding process is a purely mechanical process where natural and synthetics fiber are disentangled, blended, and intermingled by sets of needle rollers to form a continuous web with fibers aligned with the machine moving direction. Substrate materials typically include cotton, wool or viscose that can be blended with synthetic fibers; however, only synthetic fibers with no presence of natural materials are usually used in modern carded formed nonwovens. After a web is formed by carding, it can be consolidated through a variety of methods, including thermal bonding by air-through oven or calendaring, hydroentanglement, or needle punching, for example. Nonwovens from carding process typically are used in products like wet wipes, and make up various components for diapers and hygiene products.

### EXAMPLE

A series of 1.7 dTex bi-component fibers with a sheath core ratio of 65 w % to 35 w % with a cut length of 6 mm are produced. The low melting sheath material is either LLDPE by itself or LLDPE with a percentage of coPLA (i.e. a copolymer of polylactic acid) or PLA in order to evaluate the influence of additives on the fiber's ability to disperse and bond. The core of the bi-component fibers is polypropylene (PP) or coPP, and the type and level of spin-finish applied to the surface of the filaments are the same. A fiber with the same titer, sheath core ratio, cut length and PP as core material, but HDPE as sheath material, is used as a reference fiber in the evaluation of the dispersibility in an airlaid test. This test is sensitive to surface friction between fibers and openability.

The equipment for testing airlaid dispersibility and openablity involves a drum with a vertical two-bladed agitator that rotates at 49 Hz for a fiber cut length of 6 mm. At the bottom of the drum is a screen with a coarse screen that allows separated fibers to fall through the mesh under agitation. Loose fibers that fall through the coarse screen are captured in a drawer with a fine mesh screen that can be opened for inspecting and evaluation of the fibers. The fine mesh screen acts as a forming screen whereas the coarse screen simulates the forming drum of an airlaid machine.

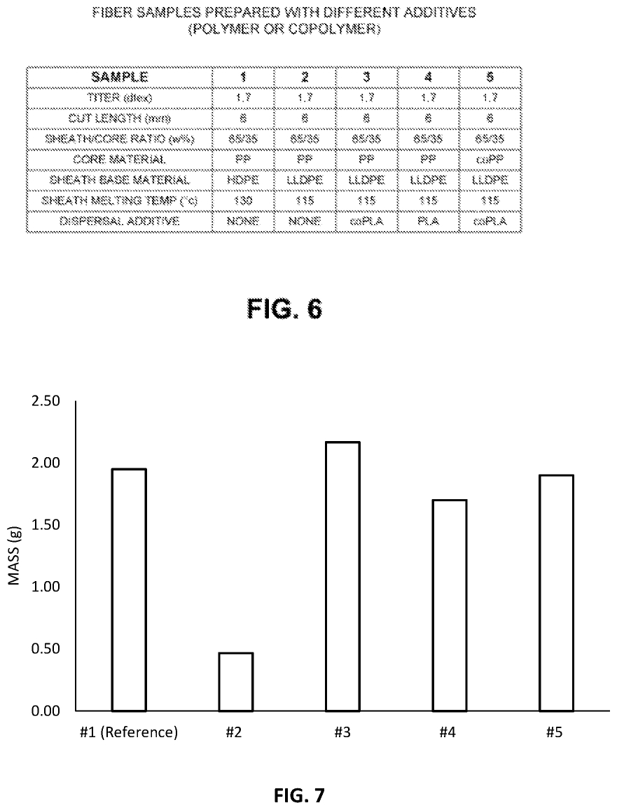

Five (5) grams of fibers are weighed out and pre-opened with compressed air of seven (7) bar in a plexiglass cylinder that is sealed with a fine mesh screen (US standard Mesh 8) at the top end. The fine screen allows air to pass through but not the fibers. The fibers are pre-opened with compressed air (approximately 7 bar) and the pre-opened fibers are transferred from the plexiglass cylinder to the agitator drum. The agitator rotates at 49 Hz for 20 seconds, where after the fibers that have fallen through the coarse screen can be inspected and the retained fibers collected to determine their mass. FIG. 6 shows the configuration of the samples used in the airlaid distribution test, and FIG. 7 shows the results of the airlaid distribution test.

The test of sample #1 showed good dispersion of the fibers with very few fused fibers, which are easily separated. In contrast, the test of sample #2 exhibits very poor dispersion of fibers with a noticeable amount of fused fibers. The fused fibers are somewhat difficult to separate by hand. However, the tests of samples # 3, #4 and #5 show similar results to that of sample #1, with good dispersion of the fibers with very few fused fibers, which are easily separated.

The mass of fibers collected from the drawer is depicted in FIG. 7, which indicates that under agitation, samples #1, #3, #4 and #5 have separated significantly more with individualized fibers compared to sample #2. Thus, samples #1, #3, #4 and #5 exhibit better dispersibility and openability.

The test proves that by adding coPLA or PLA to the LLDPE sheath material of bi-component fiber, the ability to open and disperse in an airlaid process greatly increases to an extent that is similar to that of a standard bi-component fiber with HDPE as sheath material. Without the presence of a dispersal agent in the LLDPE polymer matrix, a bi-component fiber with LLDPE as sheath material exhibits very poor dispersal and ability to separate.

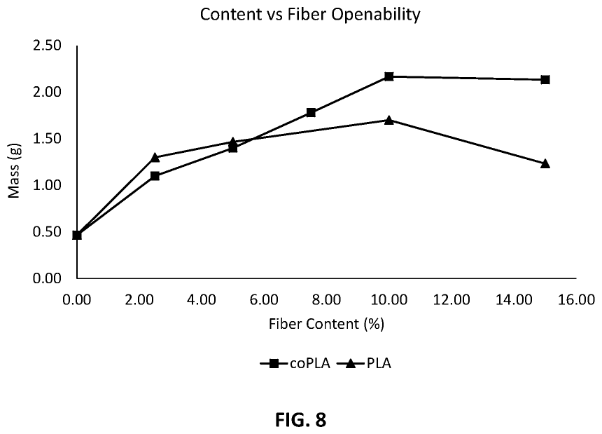

FIG. 8 is a graph depicting results of another openability test measured in content percentage versus mass of fibers.

It should be noted that all issued patents, patent publications and reference documents (for example, books and publications) mentioned above are incorporated by reference herein in their entireties.

Although various embodiments have been illustrated in the accompanying drawings and described in the foregoing Detailed Description, it should be understood the disclosure is not limited to the embodiments disclosed, but is capable of rearrangement, modification, and substitution of parts and elements without departing from the spirit of the disclosure. Additionally, the mechanism of action proposed is only for possible understanding the possible mode of action and should not be considered limiting.

1. A bi-component fiber comprising:
a core and a sheath;
a low melting polyolefin material forming a matrix; and
a polymer or copolymer suspended in the matrix as particles of the polymer or copolymer, the particles of the polymer or copolymer exhibiting increased hardness and stiffness compared to the low melting polyolefin material;
wherein the sheath is formed of the low melting polyolefin material and the polymer or copolymer suspended in the matrix;
wherein the polymer or copolymer is immiscible with the low melting polyolefin; and
wherein the polymer or copolymer is exposed along at least a portion of the exterior surface of the bi-component fiber to increase hardness of the exterior surface above a hardness provided by the low melting polyolefin material.

2. (canceled)

3. The bi-component fiber of claim 1, wherein the polymer or copolymer is selected from one or more of the group consisting of: polyethylene terephthalate, polybutylene terephthalate, polylactide, polyamide, polystyrene, polyvinyl alcohol, and acrylonitrile-butadiene-styrene.

4. The bi-component fiber of claim 1, wherein the polymer or copolymer suspended in the matrix is between 1% and 25% by weight of the low melting polyolefin.

5. (canceled)

6. (canceled)

7. (Canceled)

8. The bi-component fiber of claim 1, further comprising an adhesion promoter added to the low melting polyolefin material.

9. A composite material comprising:
a substrate; and
a plurality of bi-component fibers bonded to the substrate, wherein each of the plurality of bi-component fibers comprises:
a core and a sheath;
a low melting polyolefin material forming a matrix; and
a polymer or copolymer suspended in the matrix as particles of the polymer or copolymer, the particles of the polymer or copolymer exhibiting increased hardness and stiffness compared to the low melting polyolefin material, the polymer or copolymer being immiscible with the low melting polyolefin;
wherein, for each of the plurality of bi-component fibers, the sheath is formed of the low melting polyolefin material and the polymer or copolymer is suspended in the matrix, and the polymer or copolymer is exposed along at least a portion of the exterior surface thereof

10. (canceled)

11. The composite material of claim 9, wherein:
the plurality of bi-component fibers are bonded to the substrate by a melt bond; and
both the low melting polyolefin material and the polymer or copolymer suspended in the matrix are melted to form the melt bond.

12. (canceled)

13. A method for forming a composite material comprising:
providing a plurality of bi-component fibers, wherein each of the plurality of bi-component fibers comprises:
a core and a sheath;
a low melting polyolefin material forming a matrix; and
a polymer or copolymer suspended in the matrix as particles of the polymer or copolymer, the particles of the polymer or copolymer exhibiting increased hardness and stiffness compared to the low melting polyolefin material, the polymer or copolymer being immiscible with the low melting polyolefin;
wherein, for each of the plurality of bi-component fibers, the sheath is formed of the low melting polyolefin material and the polymer or copolymer suspended in the matrix, and the polymer or copolymer is exposed along at least a portion of the exterior surface thereof;
providing a substrate;
melting the low melting polyolefin material of the plurality of bi-component fibers to bond the plurality of bi-component fibers to the substrate; and
cooling the low melting polyolefin material and the substrate to solidify the composite material.

14. The method of claim 13, wherein providing the plurality of bi-component fibers comprises:
mixing the low melting polyolefin material and the polymer or copolymer to form a mixture;
melting the low melting polyolefin material and the polymer or copolymer of the mixture; and
extruding the mixture to form the bi-component fibers.

15. (canceled)

16. (canceled)

17. The method of claim 13, further comprising, prior to the melting and while at a temperature below a glass transition temperature of the polymer or copolymer:
opening the plurality of bi-component fibers; and
disposing the plurality of bi-component fibers on the substrate.

18. The method of claim 13, further comprising:
opening the plurality of bi-component fibers; and
layering the plurality of bi-component fibers on the substrate to form a laminate.

19. The method of claim 13, wherein:
providing the substrate comprises providing substrate components; and
the method further comprises:
opening the substrate components and the plurality of bi-component fibers; and
mixing the substrate components and the plurality of bi-component fibers to form a web.

20. (canceled)

21. (canceled)

22. The bi-component fiber of claim 1, wherein the bi-component fiber exhibits an openability of at least 1 g mass.

23. The bi-component fiber of claim 4, wherein the bi-component fiber exhibits a length of 0.5 mm to 150 mm.

24. (canceled)

25. The bi-component fiber of claim 1, wherein the low melting polyolefin material is at least 20% of the total mass of the bi-component fiber.
